(19) United States
(12) Patent Application Publication
(10) Pub. No.: US 2017/0293371 A1
(43) Pub. Date: Oct. 12, 2017

(54) OPTICAL FILM AND USER INPUT SYSTEM

(71) Applicants: CHI HSIANG OPTICS CO., LTD., Zhubei City (TW); NEOLAB CONVERGENCE TAIWAN INC., Taipei City (TW)

(72) Inventors: Po-Hung YAO, Zhubei City (TW); Feng-Chih CHEN, Taipei City (TW); Hsien-Ching CHANG, Taipei City (TW)

(21) Appl. No.: 15/479,596

(22) Filed: Apr. 5, 2017

(30) Foreign Application Priority Data
Apr. 7, 2016 (TW) 105110897

(51) Int. Cl. G06F 3/0354; G02B 1/10; G02B 5/00; G02B 5/02; G06F 3/042; G06F 3/041

(52) U.S. Cl. CPC G06F 3/03542; G06F 3/0421; G06F 3/0425; G06F 3/0414; G02B 5/003; G02B 5/0284; G02B 5/0226; G02B 1/10

(57) ABSTRACT

An optical film includes a substrate, an absorption pattern and a scattering reflection layer. The substrate has a contact surface and a back surface opposite the contact surface, wherein the substrate allows a first light to pass and is made of a non-rigid material. The absorption pattern is arranged on the contact surface of the substrate to absorb the first light. The scattering reflection layer is arranged on the back surface of the substrate to scatter and reflect the first light to the contact surface of the substrate. The foregoing optical film enables an optical reader device to detect variations of the reflected first light, which is caused by deformation of the substrate, so that the corresponding force information can be obtained. A user input system including the foregoing optical film is also disclosed.

### BACKGROUND OF THE INVENTION

### 1. Field of the Invention

The present invention relates to an optical film and a user input system, particularly to an optical film and a user input system, which allow the user to input information with a pen-like device.

### 2. Description of the Prior Art

In a conventional user input system, the substrate thereof has an encoded pattern containing addressing information. The user uses an appropriate reader device to decode the addressing information of the encoded pattern, whereby the track of the reader device moving on the surface of the substrate can be recorded. Generally, a reader device is a pen-like structure, whereby the user can interact with an electronic device in the ordinary handwriting way. Although the abovementioned conventional user input system can decode addressing information to record tracks, it cannot learn the contact force between the reader device and the substrate. Thus, the application of the conventional user input system is limited.

Therefore, the related manufacturers are eager to develop a user input system able to acquire the information of the force by which the reader device touches the substrate.

### SUMMARY OF THE INVENTION

The present invention provides an optical film and a user input system, wherein an absorption pattern and a scattering reflection layer are respectively arranged on two sides of the substrate, and wherein the reflected light varies with the deformation amount of the substrate, whereby the force by which the reader device touches the substrate is learned.

In one embodiment, the optical film of the present invention comprises a substrate, an absorption pattern and a scattering reflection layer. The substrate has a contact surface and a back surface opposite the contact surface. The substrate allows a first light to pass. The substrate is made of a non-rigid material. The absorption pattern is arranged on the contact surface of the substrate, absorbing the first light. The scattering reflection layer is arranged on the back surface of the substrate, and scatters and reflects the first light passing through the absorption pattern from gaps of the absorption pattern to the contact surface side of the substrate.

In one embodiment, the user input system of the present invention comprises an optical film and an optical reader device. The optical film further comprises a substrate, an absorption pattern and a scattering reflection layer. The substrate has a contact surface and a back surface opposite the contact surface. The substrate allows a first light to pass. The substrate is made of a non-rigid material. The absorption pattern is arranged on the contact surface of the substrate, absorbing the first light. The scattering reflection layer is arranged on the back surface of the substrate, and scatters and reflects the first light passing through the absorption pattern from gaps of the absorption pattern to the contact surface side of the substrate. The optical reader device has a pointed end used to touch the contact surface side of the optical film. The optical reader device further comprises a light-emitting unit, an image sensor, a processing unit, and a communication interface. The light-emitting unit generates a first light to illuminate the optical film. The image sensor senses the first light reflected by the scattering reflection layer and outputs a sensed image. The processing unit is electrically connected with the image sensor, analyzing the sensed image to acquire the information of the force by which the pointed end presses against the optical film. The communication interface is electrically connected with the processing unit, transmitting the information of the force to an external electronic device.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing an optical film according to a first embodiment of the present invention;

FIG. 2 is a diagram schematically showing a layout of an encoded pattern;

FIG. 3 is a diagram schematically showing another layout of an encoded pattern;

FIG. 4 is a diagram schematically showing an optical film according to a second embodiment of the present invention;

FIG. 5 is a diagram schematically showing an optical film according to a third embodiment of the present invention;

FIG. 6 is a diagram schematically showing an optical film according to a fourth embodiment of the present invention;

FIG. 7 is a diagram schematically showing a user input system according to one embodiment of the present invention; and

FIG. 8 is a diagram schematically showing an optical reader device of a user input system according to one embodiment of the present invention.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

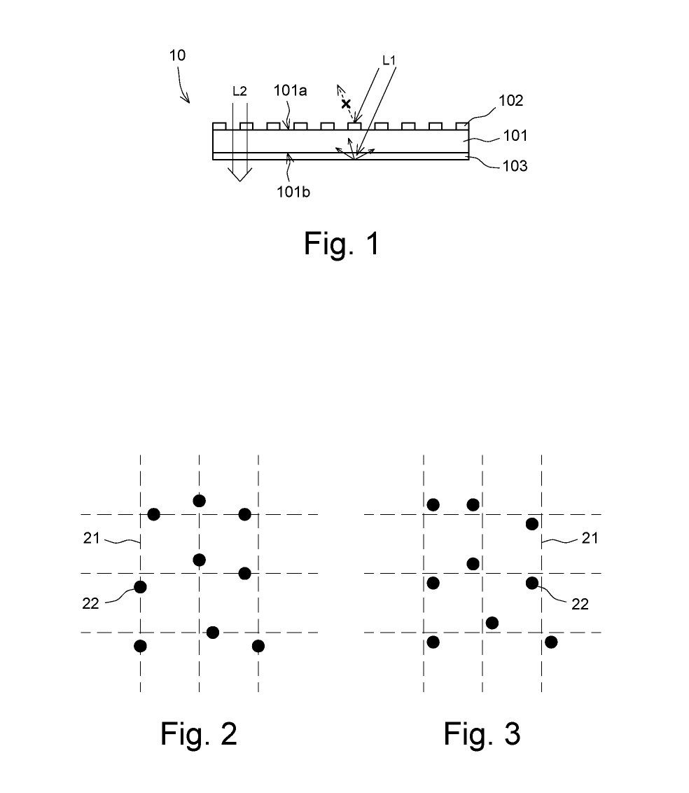

Refer to FIG. 1. In one embodiment, the optical film 10 of the present invention comprises a substrate 101, an absorption pattern 102 and a scattering reflection layer 103. The substrate 101 has a contact surface 101a and a back surface 101b opposite the contact surface 101a. The substrate 101 allows a first light L1 to pass. The substrate 101 is made of a non-rigid material. The so-called non-rigid material enables the substrate 101 to deform slightly under pressure. For example, the substrate 101 is compressed to induce a bending on the contact surface 101a. In one embodiment, a material of the substrate 101 may be polyethylene terephthalate (PET), polycarbonate (PC), polymethylmethacrylate (PMMA), polyimide (PI), cellulose triacetate (TAC), cyclic olefin polymer (COP) or PC-PMMA composite film.

The absorption pattern 102 is arranged on the contact surface 101a and able to absorb the first light L1 projecting on the absorption pattern 102, whereby the absorption pattern 102 will not reflect the first light L1. In other words, the first light L1 passes through the absorption pattern 102 from the gaps of the first absorption pattern 102. In one embodiment, the absorption rate of the first light L1 by the absorption pattern 102 is greater than 50%. In some embodiments, a material of the absorption pattern 102 may be metals, metal oxides, silicon nitride, silicon oxide, or alloys. In some embodiments, the absorption pattern 102 is in form of a plurality of geometric shapes, such as circular shapes, elliptic shapes, polygonal shapes, or a combination thereof.

The scattering reflection layer 103 is disposed on the back surface 101b of the substrate 101. The scattering reflection layer 103 can scatter and reflect the first light L1 to the contact surface 101a side of the substrate 101. In one embodiment, the scattering reflection layer 103 includes a plurality of micron or nanometric metal particles or a plurality of micron or nanometric metal oxide particles. In one embodiment, the scattering reflection layer 103 is an electroplated or coated metal layer having a surface roughness greater than 20 nm and a thickness smaller than or equal to 30 nm.

In one embodiment, a second light L2 can pass through the optical film 10. In other words, the substrate 101, the absorption pattern 102 and the scattering reflection layer 103 allow the second light L2 to pass through. For example, the absorption rate of the second light L2 by the absorption pattern 102 is smaller than 30%. It is easily understood: the wavelength of the first light L1 is different from that of the second light L2. In one embodiment, the first light L1 is an infrared light or an ultraviolet light. In a preferred embodiment, the first light L1 is an infrared light, and the second light L2 is a visible light.

According to the structure shown in FIG. 1, while an optical reader device (not shown in FIG. 1) touches the contact surface 101a side of the substrate 101 slightly, the optical reader device can capture the first light L1 reflected by the scattering reflection layer 103 to function a first image. While the optical reader device applies a greater pressure to the contact surface 101a of the substrate 101, the substrate 101 deforms, and the optical reader device obtains a second image, which is different from the first image. The information of the force the optical reader device applies to the contact surface 101a of the substrate 101 can be obtained via analyzing the variation of the second image. For example, while the optical reader device applies a greater pressure, the following three cases may occur: the distance between the contact surface 101a and the back surface 101b is decreased, whereby the optical reader device captures a higher intensity of the reflected first light L1; the reflecting surface of the scattering reflection layer 103 deviates from the focal plane of the optical reader device, whereby the optical reader device obtains a second image different from the first image; the pressure applied by the optical reader device causes the contact surface 101a of the substrate 101 to deform, which results in that the absorption pattern 102 in the second image is different from the absorption pattern 102 in the first image, wherefore the information of the force applied by the optical reader device can be obtained via analyzing the variation of the absorption pattern 102.

In one embodiment, the absorption pattern 102 includes an encoded pattern, which can be decoded by the optical reader device to obtain at least one of addressing information, text information and graphic information. It is easily understood: the absorption pattern 102 can be an encoded pattern or is independent from the encoded pattern. The encoded pattern can also absorb the first light L1, whereby the encoded pattern will not reflect the first light L1 projecting onto the encoded pattern. In other words, the first light L1 passes through the encoded pattern from the gaps of the encoded pattern. In one embodiment, the absorption rate of the first light L1 by the encoded pattern is greater than 50%. In some embodiments, a material of the encoded pattern may be metals, metal oxides, silicon nitride, silicon oxide, or alloys. In some embodiments, the encoded pattern is in form of a plurality of geometric shapes, such as circular shapes, elliptic shapes, polygonal shapes, or a combination thereof.

Refer to FIG. 2. In one embodiment, the encoded pattern includes virtual grid lines 21 and a plurality of marks 22. The virtual grid lines 21 are not really depicted on the optical film 10 and thus drawn with dotted lines in FIG. 2. In one embodiment, the virtual grid lines 21 intersect vertically to form a plurality of intersection points. The addressing information, text information or graphic information is encoded according to the positions of the marks 22 with respect to the intersection points of the virtual grid lines 21. In one embodiment, the marks 22 are respectively arranged at the positions respectively 0 degrees, 90 degrees, 180 degrees and 270 degrees with respect to the intersection points of the virtual grid lines 21 to represent four different values. Thus, the addressing information, text information or graphic information can be encoded with the marks 22. Refer to FIG. 3. In one embodiment, the marks 22 are respectively arranged at the positions respectively 45 degrees, 135 degrees, 225 degrees and 315 degrees with respect to the intersection points of the virtual grid lines 21 to represent four different values. The detailed encoding method is not the focus of the present invention but a technology well known by the persons skilled in the art. Therefore, it will not repeat herein. In addition to the abovementioned encoding method, the addressing information, text information or graphic information can also be encoded with other appropriate methods.

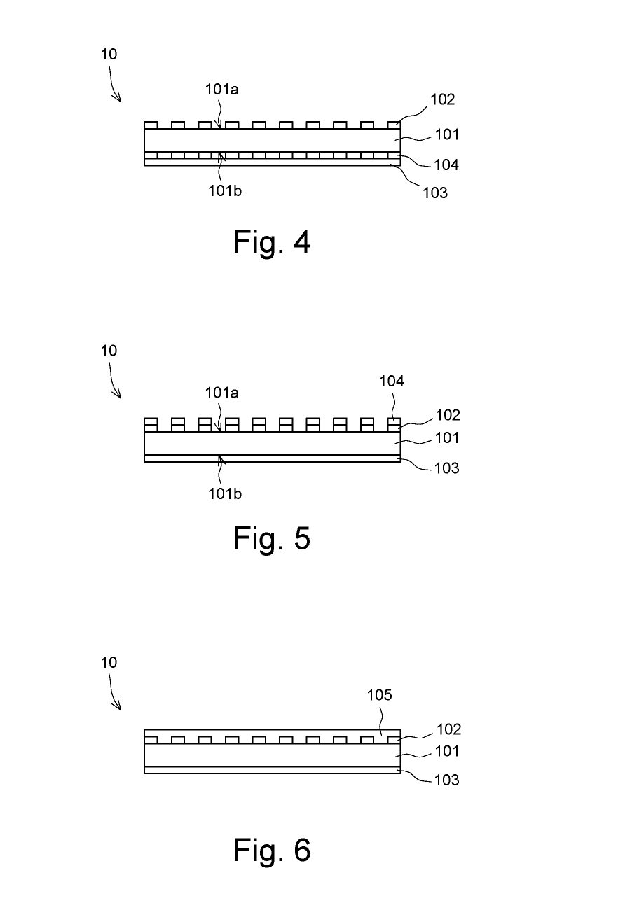

Refer to FIG. 4 and FIG. 5. In one embodiment, the encoded pattern 104 and the absorption pattern 102 are disposed separately. For example, the encoded pattern 104 is disposed on the back surface 101b of the substrate 101, i.e. interposed between the substrate 101 and the scattering reflection layer 103, as shown in FIG. 4. In one embodiment, the encoded pattern 104 is disposed on the contact surface 101a side of the substrate 101, as shown in FIG. 5. It should be explained: either the encoded pattern 104 or the absorption pattern 102, which is disposed on the outmost side of the contact surface 101a of the substrate 101, can be used to realize the present invention.

Refer to FIG. 6. In one embodiment, the optical film of the present invention further comprises a coating layer 105 covering the absorption pattern 102 lest the absorption pattern 102 be worn out by the optical reader device touching the absorption pattern 102 frequently. In one embodiment, the coating layer 105 has at least one of a hard-coating effect, an anti-glare effect, an anti-reflection effect, an anti-fingerprint effect, and an anti-electrostatic effect.

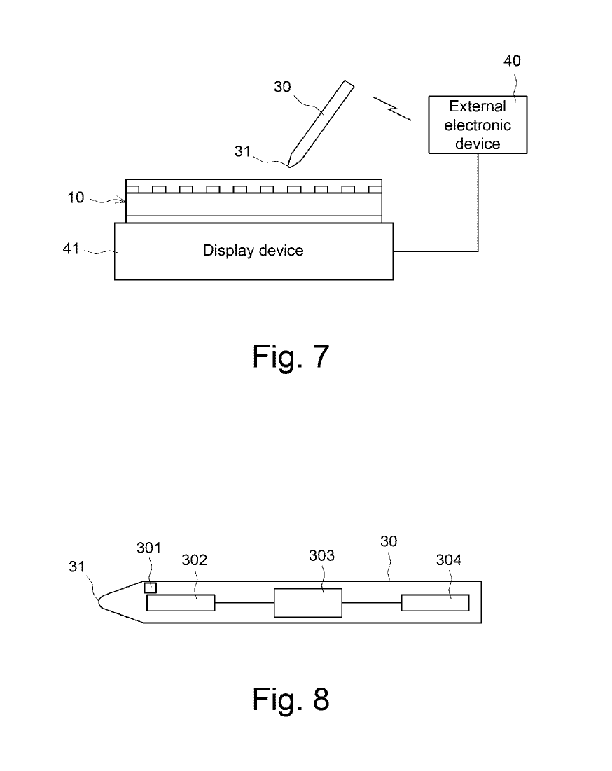

Refer to FIG. 7 and FIG. 8. In one embodiment, the user input system of the present invention comprises an optical film 10 and an optical reader device 30. The structure of the optical film 10 has been described above in detail and will not repeat herein. The optical reader device 30 has a pointed end 31 used to touch the contact surface 101a side of the optical film 10, whereby the user can interact with the electronic device in the ordinary handwriting way. The optical reader device 30 comprises a light-emitting unit 301, an image sensor 302, a processing unit 303, and a communication interface 304.

The light-emitting unit 301 generates a first light L1 projecting onto the optical film 30. In some embodiments, the light-emitting unit 30 is an infrared light-emitting diode (LED) or an ultraviolet LED. In a preferred embodiment, the light-emitting unit 301 is an infrared LED. The image sensor 302 senses the first light L1 reflected by the scattering reflection layer 103 and outputs a sensed image. In some embodiments, the image sensor 302 includes a lens and also includes a charge coupled device (CCD) or a complementary metal oxide semiconductor (CMOS) sensor. In some embodiments, the lens is made of poly methyl methacrylate (PMMA). In some embodiments, the lens is fabricated in an injection-molding method. PMMA is abrasion-resistant and has a light transmittance of about 90% at a wavelength peak of 810 nm. In some embodiments, the CCD or CMOS sensor has 128×128 pixels. In a preferred embodiment, the CCD or CMOS sensor has 140×140 pixels so as to achieve a higher tolerance of fabrication error.

The processing unit 303 is electrically connected with the image sensor 302. The processing unit 303 can analyze the sensed image to obtain the information of the force by which the pointed end 31 of the optical reader device 30 presses against the optical film 10. For example, the processing unit 303 can analyze the light intensity, pattern variation, or orientation variation of the sensed image to obtain the information of the force by which the pointed end 31 of the optical reader device 30 presses against the optical film 10. It is easily understood: while the optical film 10 has the encoded pattern, the processing unit 303 can obtain at least one of the addressing information, the text information, and the graphic information via analyzing the sensed image. The communication interface 304 is electrically connected with the processing unit 303. The communication interface 304 can transmit the force information, addressing information, text information, and graphic information, which is obtained by the processing unit 303, to an external electronic device 40. In some embodiments, the communication interface 304 is a wired or wireless communication interface. In a preferred embodiment, the communication interface 304 is a wireless communication interface, whereby the user is exempted from the annoyance of cables while writing with the optical reader device. In some embodiments, the wireless communication interface 304 is a Bluetooth device, a wireless local area network (WLAN) device, a ZigBee device, a wireless USB device, or a mobile communication network device.

In one embodiment, the user input system further comprises a display device 41, which is arranged on the back surface 101b side of the optical film 10. In other words, the optical film 10 is disposed on the display surface of the display device 41. The display device 41 is electrically connected with the external electronic device 40, whereby the external electronic device 40 can present at least one of the force information, addressing information, text information and graphic information, which is received from the optical reader device 30, on the display device 41 in realtime. For example, while the user uses the optical reader device 30 to sign or draw on the display device 41 having the optical film 10 of the present invention, the external electronic device 40 can instantly present on the corresponding position of the display device 41 the signature or drawing with the pen touch thereof.

In conclusion, the present invention proposes an optical film and a user input system, wherein an absorption pattern and a scattering reflection layer are respectively arranged on two surfaces of the substrate, and wherein the information of the force by which the optical reader device touches the optical film can be obtained via detecting the reflected light variation caused by the deformation of the substrate, whereby the pen touch can be presented more truly.

The technical contents and characteristics of the present invention have been demonstrated above with the embodiments to enable the persons skilled in the art to understand, make, and use the present invention. However, these embodiments are only to exemplify the present invention but not to limit the scope of the present invention. Any equivalent modification or variation according to the spirit of the present invention is to be included within the scope of the present invention.

What is claimed is:

1. An optical film comprising:
a substrate having a contact surface and a back surface opposite the contact surface, allowing a first light to pass, and made of a non-rigid material;
an absorption pattern arranged on the contact surface of the substrate and absorbing the first light;
a scattering reflection layer arranged on the back surface of the substrate, and scattering and reflecting the first light passing through the absorption pattern from gaps of the absorption pattern to the contact surface side of the substrate.

2. The optical film according to claim 1, wherein the substrate, the absorption pattern and the scattering reflection layer allow a second light to pass, and wherein the first light and the second light respectively have different wavelengths.

3. The optical film according to claim 2, wherein the first light is an infrared light, and the second light is a visible light.

4. The optical film according to claim 2, wherein an absorption rate of the first light by the absorption pattern is greater than 50%, and an absorption rate of the second light by the absorption pattern is smaller than 30%.

5. The optical film according to claim 1, wherein the absorption pattern is in form of a plurality of geometric shapes, and wherein the geometric shapes comprise circular shapes, elliptic shapes, polygonal shapes, or a combination thereof.

6. The optical film according to claim 1, wherein the absorption pattern comprises an encoded pattern, and wherein the encoded pattern comprises at least one of addressing information, text information, and graphic information.

7. The optical film according to claim 1 further comprising:
an encoded pattern arranged between the substrate and the scattering reflection layer or arranged on the contact surface side of the substrate, wherein the encoded pattern absorbs the first light and comprises at least one of addressing information, text information and graphic information.

8. The optical film according to claim 7, wherein the encoded pattern is in form of a plurality of geometric shapes, and wherein the geometric shapes comprise circular shapes, elliptic shapes, polygonal shapes, or a combination thereof.

9. The optical film according to claim 1, wherein a material of the substrate comprises polyethylene terephthalate (PET), polycarbonate (PC), polymethylmethacrylate (PMMA), polyimide (PI), cellulose triacetate (TAC), cyclic olefin polymer (COP) or PC-PMMA composite film.

10. The optical film according to claim 1, wherein a material of the absorption pattern comprises metals, metal oxides, silicon nitride, silicon oxide, or alloys.

11. The optical film according to claim 1, wherein the scattering reflection layer comprises a plurality of micron or nanometric metal particles, or a plurality of micron or nanometric metal oxide particles.

12. The optical film according to claim 1, wherein the scattering reflection layer is an electroplated or coated metal layer having a surface roughness greater than 20 nm and a thickness smaller than or equal to 30 nm.

13. The optical film according to claim 1 further comprising:
a coating layer covering the absorption pattern and having at least one of a hard-coating effect, an anti-glare effect, an anti-reflection effect, an anti-fingerprint effect, and an anti-electrostatic effect.

14. A user input system comprising:
an optical film comprising:
a substrate having a contact surface and a back surface opposite the contact surface, allowing a first light to pass, and made of a non-rigid material;
an absorption pattern arranged on the contact surface of the substrate and absorbing the first light; and
a scattering reflection layer arranged on the back surface of the substrate, and scattering and reflecting the first light passing through the absorption pattern from gaps of the absorption pattern to the contact surface side of the substrate; and
an optical reader device having a pointed end used to touch the contact surface side of the optical film and comprising:
a light-emitting unit generating the first light projecting onto the optical film;
an image sensor sensing the first light reflected by the scattering reflection layer and outputting a sensed image;
a processing unit electrically connected with the image sensor, analyzing the sensed image to obtain information of a force by which the pointed end presses against the optical film; and
a communication interface electrically connected with the processing unit and transmitting information of the force to an external electronic device.

15. The user input system according to claim 14, wherein the substrate, the absorption pattern and the scattering reflection layer allow a second light to pass, and wherein the first light and the second light respectively have different wavelengths.

16. The user input system according to claim 15, wherein the first light is an infrared light, and the second light is a visible light.

17. The user input system according to claim 14, wherein the absorption pattern is in form of a plurality of geometric shapes, and wherein the geometric shapes comprise circular shapes, elliptic shapes, polygonal shapes, or a combination thereof.

18. The user input system according to claim 14 further comprising:
a display device arranged on the back surface side of the optical film and electrically connected with the external electronic device.

19. The user input system according to claim 14, wherein the absorption pattern comprises an encoded pattern, and wherein the encoded pattern comprises at least one of addressing information, text information and graphic information, and wherein the processing unit decodes the sensed image to obtain at least one of the addressing information, the text information and the graphic information.

20. The user input system according to claim 14, wherein the optical film further comprising:
an encoded pattern arranged between the substrate and the scattering reflection layer or arranged on the contact surface side of the substrate, wherein the encoded pattern absorbs the first light and comprises at least one of addressing information, text information and graphic information, and wherein the processing unit decodes the sensed image to obtain at least one of the addressing information, the text information and the graphic information.

21. The user input system according to claim 14, wherein a material of the absorption pattern comprises metals, metal oxides, silicon nitride, silicon oxide, or alloys.

22. The user input system according to claim 14, wherein the scattering reflection layer comprises a plurality of micron or nanometric metal particles, or a plurality of micron or nanometric metal oxide particles.

23. The user input system according to claim 14, wherein the scattering reflection layer is an electroplated or coated metal layer having a surface roughness greater than 20 nm and a thickness smaller than or equal to 30 nm.

24. The user input system according to claim 14, wherein the optical film further comprising:
a coating layer covering the absorption pattern and having at least one of a hard-coating effect, an anti-glare effect, an anti-reflection effect, an anti-fingerprint effect, and an anti-electrostatic effect.

25. The user input system according to claim 14, wherein the communication interface is a wireless communication interface.
